(19) United States
(12) Patent Application Publication
(10) Pub. No.: US 2011/0316687 A1
(43) Pub. Date: Dec. 29, 2011

(54) Spare Tire Pressure Monitor

(76) Inventor: James Riley, Natchez, MS (US)

(21) Appl. No.: 12/823,919

(22) Filed: Jun. 25, 2010

(51) Int. Cl. B60C 23/00

(52) U.S. Cl. 340/445

(57) ABSTRACT

A spare tire monitor that connects directly over the valve stem in order to provide a driver with a means of being notified when the spare tire experiences a significant loss of air. The spare tire monitor relates to a conduit that attaches a first connection to either the internal electrical system of a vehicle or a gauge mounted at the dashboard while a second connection on the opposite end of the vehicle covers the valve stem of a spare tire such that an alert will occur when air pressure falls below a certain desired threshold.

### FIELD OF THE PRESENT INVENTION

The present invention relates to a conduit that attaches a first connection to either the internal electrical system of a vehicle or a gauge mounted at the dashboard while a second connection on the opposite end of the vehicle attaches to the valve stem of a spare tire such that an alert will occur when the tire's air pressure falls below a certain desired threshold.

### BACKGROUND OF THE PRESENT INVENTION

Driving a vehicle is simply a fact of life for millions of people every day. Another factor of life is that drivers will definitely experience a flat tire while operating the vehicle. In fact, statistics reveal that the average motorist will endure about five flat tires in his or her lifetime. This number is exponentially higher for those who are on the road more often. In addition, the flat tires often do not occur at the most convenient times. This means that a vehicle is likely to be disabled by a flat tire during inclement weather, in the middle of heavy traffic, dangerous surroundings, during a time crunch or all of the above.

The scenario with flat tires can be minimized, however, with proper monitoring of the air pressure. It is quite common to see people using handheld gauges and stopping at air pumps to assess the level of air contained within the tires. Monitoring the air pressure of active tires clearly minimizes the risk of blowout while also assists in other elements such as fuel efficiency. But during the inevitable blowout—whether it is from a puncture or natural reasons—the person will have to change the disabled tire to a spare. A problem then comes into play due to the fact that while many people monitor the air pressure of the active tires, most people at the same time do not monitor the air levels of the spare tire.

What typically happens is that a driver will either call for help or fix the flat tire on his or her own initiative. Fixing the flat generally requires going to the trunk or rear of the vehicle and removing the spare tire as a replacement. But again, the problem remains that the majority of drivers do not include monitoring the air pressure of the spare. It also has been reported that most people likely have never inspected the spare tire's air pressure and instead operate on the assumption that the spare will be ready and reliable for use. The problematic result is that drivers have found themselves stranded in varying levels of external conditions. Many times, cell phone batteries have been dead and/or mobile phone service was not available. With a disabled tire and a flat spare tire, these drivers have had to endure difficult situations. In that respect, there is a need for a cost-effective system that automatically monitors the air levels of the spare tire without the driver having to exert additional effort.

The reason many spare tires are rendered flat or dangerously low on air is typically natural. Spare tires often lose air through permeation, which is related to changes in external temperature. Just like active tires, changes from cold weather to hot temperatures can hasten the permeation of air from within the spare tire. According to various expert sources, a tire may lose one or two pounds of air per month in cool weather. Again, this process is hastened in warmer temperatures. It also should be noted that under-inflation is the leading cause of tire failure and is common in spare tires, as well as active tires. Under-inflation creates excessive stresses and heat, which ultimately can lead to a dilapidated spare tire. If the spare tire is not completely flat, the result may be that, just like with faulty active tires, vehicle damage and/or serious injury or death may occur from the use of a spare tire that fails due to over-inflation, under-inflation or a condition called overloading. Again, this scenario highlights the need for a system that alerts the person when the spare tire crosses a threshold of air pressure contained within the spare tire.

For those who monitor their active tires, this process of permeation and under-inflation is rectified with standard tire maintenance. But, again, most people do not think to monitor the air levels contained within the spare tire. For example, many people may maintain clean vehicles, but their trunks at the same time may be full of contents that make it extremely difficult and inconvenient to even get to the spare tire. In this manner, the spare tire may have lost air through puncture or permeation, and the driver would never know until it is potentially too late. As such, the problem extends to the fact that there lacks a system that accounts for the fact that people will not be able to monitor their spare tires as part of their active tire maintenance regiment.

There have been efforts to handle this problem. For example, some companies such as AMERITYRE claim to directly tackle this issue by constructing a different type of tire made of polyurethane elastomer in an effort to maintain a more reliable spare. However, ideas such as this are not necessarily cost effective and do not alert the driver if there is indeed a problem. This is particularly true in the event that the spare is removed by someone else or is punctured. In situations such as that, the driver may never know that there is either an absence of a spare or a punctured spare. In contrast, the present invention provides a cost-effective solution by connecting the vehicle electrical system to the actual valve stem of the spare tire via a conduit. This means that if the spare tire is missing or punctured, the driver will know via an alert message when the vehicle is started.

U.S. Pat. No. 6,369,703 issued to Lill on Apr. 9, 2002 is a tire pressure monitor and location identification system. Lill uses transponders and unique codes connected to each tire in order to monitor the air pressure. Unlike the present invention, Lill requires computerized resources and relatively expensive internal composition and programming to achieve its monitoring goals. In contrast, the present invention connects a conduit directly over the valve stem of the spare tire, with the conduit leading to a gauge at the front of the vehicle that can either be mounted to the dashboard or placed in communication with the electrical system of the vehicle. In this manner, the present invention is much more cost effective and functions using different placements and mechanisms.

There are a number of similar items that rely on computerized resources and relatively expensive internal composition while failing to function by enveloping a connection directly over the valve stem of the spare tire. This includes U.S. Patent Application 2008/0100429 filed by Luo et al on May 1, 2008. Luo is a tire pressure monitoring and remote keyless entry system for a vehicle. There is also U.S. Pat. No. 4,067,376 issued to Barabino on Jan. 10, 1978 and U.S. Pat. No. 6,758,089 issued to Breed et al on Jul. 6, 2004. Barabino is a tire pressure warning system that uses sensors located in proximity to each wheel. Breed is a wireless sensing and communications system that engages sensors to monitor various aspects of the vehicle. Unlike the present invention, items such as Luo, Barabino, and Breed do not place a conduit directly in communication with the dashboard on one end of the vehicle and the valve stem of the spare tire via a second connection on the other end of the vehicle.

As stated above, there remains a need for a cost-effective and convenient means of monitoring the spare tire of a vehicle. The spare tire generally is an item that is ignored and forgotten until a flat tire causes the spare to be necessary. As such, there is a need for a system that permits people to place a gauge and/or alert mechanism in communication to the dashboard and/or electrical system of the vehicle, while also connecting such items directly into the valve stem of the spare tire. The present invention solves this need, and in doing so provides a system for monitoring the air level of a spare tire without expending additional and costly energy.

### SUMMARY OF THE PRESENT INVENTION

The present invention is a system for monitoring the air level contained within a spare tire. Typically, the spare tire will be located at the rear of the vehicle such as within a trunk. The present invention serves to monitor the air level contained within the spare tire via a conventional gauge located in view of the driver. When the air level is reduced for whatever reason to the point where the spare tire is either dangerously low or otherwise ineffective or unsafe for use, the present invention will cause an alert to be provided through either the gauge or the vehicle computer or electrical system. In this manner, a user will know that he or she cannot rely on the spare tire in that condition.

The primary components of the present invention are a conduit, a first connection to the gauge, and a second connection that attaches directly over the valve stem of the spare tire. The second connection is configured as a threaded cap with a pressure release stem that attaches to the valve stem of the spare tire, creating a connection via the conduit to the first connection and the gauge that constantly monitors the air pressure contained within the spare tire. An embodiment of the present invention in which a user attaches the conduit directly onto the valve stem and mounts the gauge in view of the driver at the dashboard, can be conducted without a manufacturer.

However, an additional embodiment relates to incorporating the gauge with the electrical system of the vehicle. In this embodiment, the first connection of the conduit is configured to directly communicate with the electrical or computer system of the vehicle, as well as the gauge. In this manner, the conduit extends from the valve stem of the tire to the vehicle's electrical system via the gauge. The first connection is connected to an audio and/or visual alert such as a dashboard/instrument panel icon or beeping noise. When the gauge detects an unsafe amount of air pressure, the alert will be activated via conventional means. For purely electrical systems relating to a fuse, the circuit will remain open so long as the present invention monitors safe levels of air pressure within the spare tire. But when the present invention monitors a dangerous level of air pressure, the circuit will be closed and the alert will be activated.

### BRIEF DESCRIPTION OF THE DRAWINGS

FIG. 1 is a view of the present invention in its preferred embodiment.

FIG. 2 is a view of the second connection of the present invention in its preferred embodiment.

FIG. 3 is a view of an additional embodiment of the present invention relating to a wireless transmitter.

FIG. 4 is an additional view of the present invention in terms of its components.

### DETAILED DESCRIPTION OF THE PREFERRED EMBODIMENT

The function of the present invention is such that a user will be notified via a conventional alert when the air pressure of a spare tire (5) is rendered low. In this manner, the user will be informed if the spare tire (5) has lost a necessary amount of air through natural loss or puncture, and the user can then act accordingly.

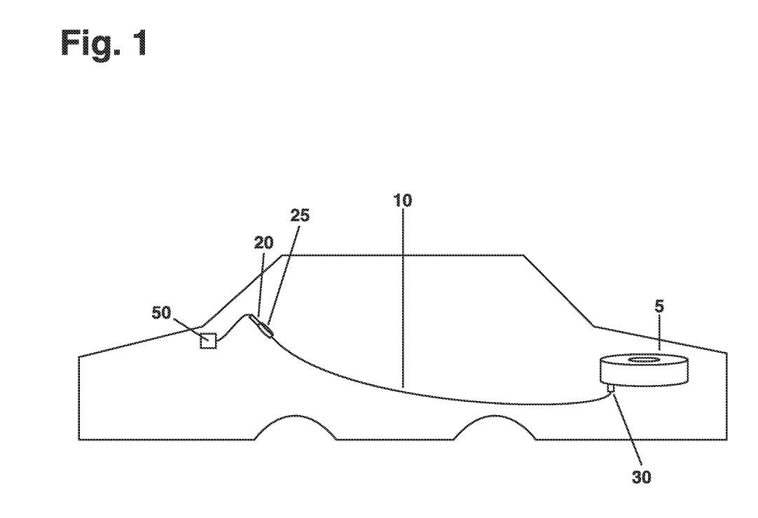

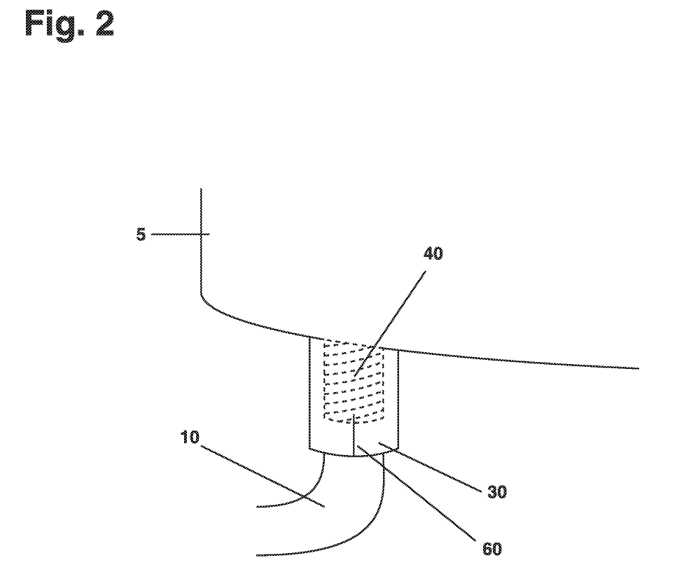

As we see in FIG. 1, a conduit (10) is used to connect the vehicle and alert mechanism to the spare tire (5). The conduit (10) in the preferred embodiment is formed via a flexible nylon material. The conduit (10) is formed such that the air pressure of the spare tire (5) can be displayed on the gauge (25). Although the preferred embodiment of the conduit (10) is nylon, other materials such as wire are envisioned. The spare tire (5) in the preferred embodiment, as shown in FIG. 1, is located at the rear of the vehicle. In the preferred embodiment, the spare tire (5) will be placed onto the floor of the trunk or on the rear of the vehicle such as is the case with certain forms of jeeps or trucks. The placement of the spare tire (5) in the preferred embodiment is so that the side of the spare tire (5) that features the protruding valve stem (40) (not shown in FIG. 1, see FIG. 2) is placed toward the vehicle interior. For example, the spare tire (5) located in the trunk will be placed so that the valve stem (40) (not shown in FIG. 1, see FIG. 2) is facing the bottom flooring of the trunk. A spare tire (5) attached or hung to the back of a vehicle will be positioned so that the valve stem (40) (not shown in FIG. 1, see FIG. 2) is facing the vehicle.

The second connection (30) is placed in communication with the valve stem (40) (not shown in FIG. 1, see FIG. 2). The second connection (30) is a quick connect threaded cap with a pressure release stem (60) that screws onto and completely envelops the valve stem (40) (not shown in FIG. 1, see FIG. 2) without causing any air loss from the spare tire (5). The conduit (10) is attached to the second connection (30) so that the conduit (10) extends from the second connection (30) and runs toward the front of the vehicle within the framing or interior elements of the vehicle. In this manner, the conduit (10) will not get in the way of people or objects placed within the interior of the vehicle. Instead, the conduit (10) in the preferred embodiment will run along unobtrusive routes within the interior of the vehicle, as do brake light conduits and trunk opening alerts.

As shown in FIG. 1, the first connection (20) also is attached to the conduit (10) and is directly in communication with the gauge (25). From the point of the gauge (25), the first connection (20) also may be attached to the vehicle's electrical system (50). The electrical system (50) may be associated with the vehicle computer system, dashboard/instrument panel, and/or fuse system. As such, the present invention ultimately places the air pressure of the spare tire (5) in communication with the electrical system (50) of the vehicle. What then happens is that the first connection (20) is placed in communication with an audio and/or visual alert such as a dashboard icon or beeping noise. The alert is powered by the vehicle's electrical system (50), such as a conventional fuse. When the gauge (25) detects an unsafe level of air pressure in the spare tire (5), the alert will be activated via conventional means through the electrical system (50). For purely electrical systems (50) relating to a fuse, the circuit will remain open so long as the present invention monitors safe levels of air pressure within the spare tire (5). But when the present invention monitors an unsafe level of air pressure, the circuit will be closed and the alert will be activated.

FIG. 2 provides a view of the preferred embodiment of the present invention where the second connection (30), which is a quick connect threaded cap with a pressure release stem (60), attaches to the valve stem (40) of the spare tire (5). It is attached by screwing the second connection (30) onto the valve stem (40) by means of conventional threads. The valve stem (40), extending from the spare tire (5), is completely enveloped by the second connection (30), with the pressure release stem (60) engaging the valve stem (40), so that the air pressure of the spare tire (5) can be monitored. The conduit (10) is shown attached to the second connection (30).

Another embodiment of the present invention (not shown in a figure) envisions the second connection (30) installed in the trunk of a vehicle where a spare tire (5) is placed. In this embodiment, the second connection (30) is fixed into the floor of the trunk so that a spare tire (5) can be placed into the trunk, and the valve stem (40) of the spare tire (5) can be aligned with and fastened to the second connection (30). Once the valve stem (40) is fastened to the second connection (30), the present invention functions to monitor the air pressure of the spare tire (5) and issue an alert if necessary.

It should be noted that while the focus of the present invention relates to spare tires (5), the present invention also could be applied to other tires, including active ones that are in use. In that embodiment (not shown in a figure), a conventional rotor would be attached to the second connection (30) to compensate for the spinning of the tires. The conduit (10) would run through a cylinder within the center of the tires and on up into the interior of the vehicle and toward the vehicle's electrical system (50).

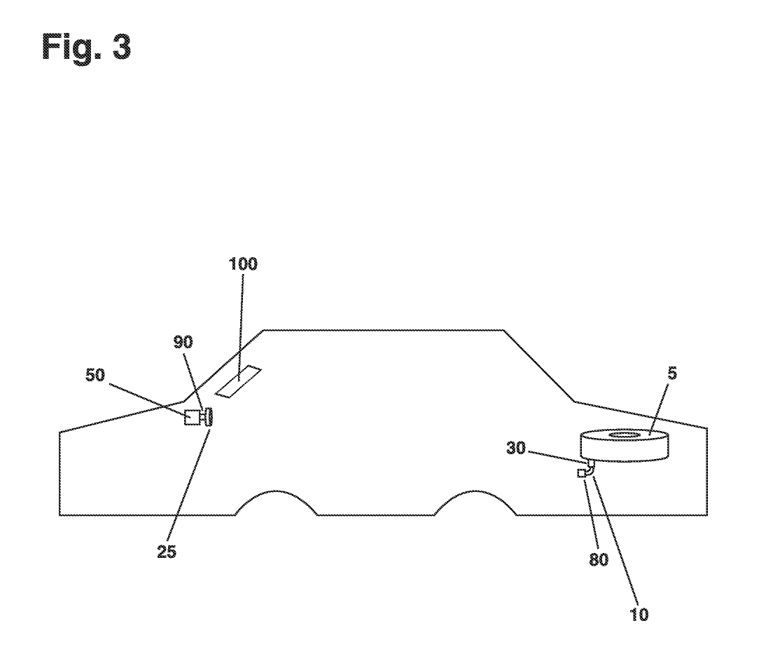

An additional embodiment of the present invention is shown in FIG. 3, and relates to a wireless transmitter (80). In this embodiment, the present invention operates similarly as described above in terms of the spare tire (5) in communication with the second connection (30). However, in this embodiment a transmitter (80) is connected to the conduit (10) at a point close to the spare tire (5). The transmitter (80) is in communication with a sensor (90) located within the electrical system (50) or onboard computer system of the vehicle that is connected via conventional means to a gauge (25) or to the vehicle's dashboard (100). The transmitter (80) will conventionally transmit the status of the air pressure contained within the spare tire (5) to the sensor (90) located within the electrical system (50) or onboard computer system of the vehicle. In this embodiment, the sensor (90) and electrical system (50) will operate to provide tire pressure information on the gauge (25) or the dashboard (100), and an alert will notify the user if there is an issue with the air pressure of the spare tire (5).

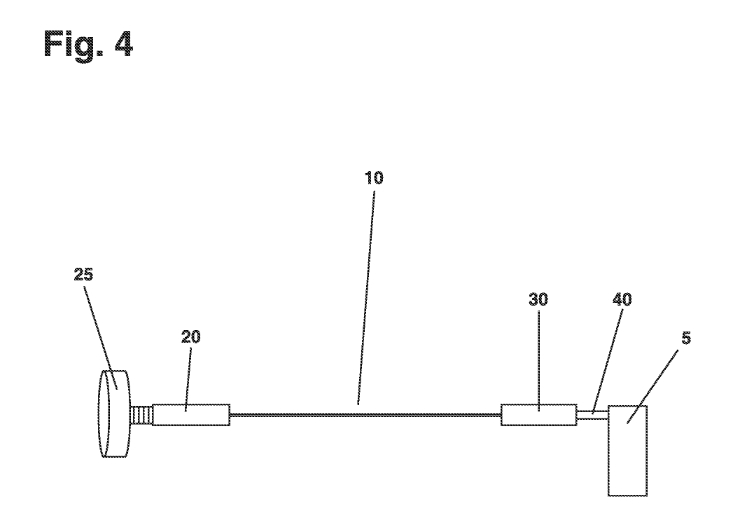

FIG. 4 also describes a view of the present invention in regard to its component aspects. The parts of the present invention shown are the gauge (25), first connection (20), conduit (10), and second connection (30), and also shown are a valve stem (40) and spare tire (5). The view in FIG. 4 demonstrates how the aforementioned components of the present invention can be installed and removed from the vehicle by a user in a relatively simple and cost-effective manner, by running the nylon conduit (10) from the valve stem (40) at the second connection (30) to the first connection (20) and gauge (25) placed in view of the driver (e.g., by being mounted on the dashboard).

In summary, the present invention comprises a conduit, a gauge attached to the conduit via a first connection, and a second connection configured to cover a valve stem of the spare tire via an opening formed within the second connection. The gauge is configured to monitor air pressure within the spare tire via the valve stem, through the second connection, through the conduit, and into the gauge. The conduit is configured to extend from the valve stem located at the rear of a vehicle to the front of the vehicle. The conduit is constructed out of a nylon material, and runs toward the front of the vehicle from the rear of the vehicle within the interior elements of the vehicle. For a tire placed in the trunk of the vehicle, the conduit runs toward the front of the vehicle from the trunk of the vehicle within the interior elements of the vehicle.

Further describing the spare tire monitor, the first connection is in communication with an electrical system of the vehicle, whether a fuse of the vehicle and a dashboard of the vehicle, or an onboard computer of the vehicle and a dashboard of the vehicle. The spare tire monitor's gauge is mounted on the dashboard of the vehicle, with the gauge configured to issue an alert when a threshold of air pressure loss is detected by the gauge. The alert is configured to appear visually or audibly within the gauge that is mounted on the dashboard, or the alert is configured to appear on the dashboard via a connection between the electrical system of the vehicle and the first connection.

In another embodiment of the present invention, the spare tire monitor comprises a first connection and a second connection to a conduit, the second connection placed over a valve stem of the spare tire such that the valve stem is completely enveloped by an opening of the second connection. The second connection is locked in place over the valve stem. A gauge is incorporated to the first connection such that the gauge is configured to monitor air pressure coming from the valve stem, through the second connection, through the conduit and into the gauge, with the present invention issuing an alert when air pressure contained in the spare tire is detected by the gauge to be less than a desirable amount. The gauge will be mounted in view of a driver. The first connection is linked to an electrical system of the vehicle such that an alert can be issued when air pressure contained in the spare tire is detected by the gauge to be less than a desirable amount.

Furthermore, the present invention comprises running the conduit from the second connection, through internal elements of the vehicle and into the front of the vehicle. One embodiment of the conduit envisions the conduit as formed of nylon. Another embodiment of the spare tire monitor comprises forming a slot into a trunk of a vehicle such that the slot is stationary and protrudes upward, with the spare tire placed so that the valve stem is facing downward toward the floor of the trunk such that the valve stem can be lined up with the slot of the second connection so that the locking mechanism can lock the valve stem in place. A spare tire monitor, comprising attaching a first connection and a second connection to a conduit placing the second connection over a valve stem of the spare tire such that the valve stem is completely enveloped by the second connection, locking the second connection in place over the valve stem, attaching a transmitter to the first connection of the conduit, placing the transmitter in communication with the gauge, transmitting a status of air pressure contained within the spare tire to a sensor located within an electrical system of a vehicle; and alerting a person when air pressure contained in the spare tire is detected by the gauge and transmitted to the sensor to be less than a desirable amount.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

I claim:

1. A spare tire monitor, comprising:
a conduit;
a gauge attached to said conduit via a first connection;
a second connection configured to cover a valve stem of said spare tire via an opening formed within the second connection;
said gauge configured to monitor air pressure within said spare tire via said valve stem, through said second connection, through said conduit, and into said gauge; and
said conduit configured to extend from said valve stem located at a rear of a vehicle to a front of said vehicle.

2. The spare tire monitor of claim 1, wherein said conduit is constructed out of a nylon material.

3. The spare tire monitor of claim 1, wherein said conduit runs toward said front of said vehicle from said rear of said vehicle within the interior elements of said vehicle.

4. The spare tire monitor of claim 3, wherein said wherein said conduit runs toward said front of said vehicle from a trunk of said vehicle within the interior elements of said vehicle.

5. The spare tire monitor of claim 1, wherein said first connection is in communication with an electrical system of said vehicle.

6. The spare tire monitor of claim 5, wherein said first connection is in communication with a fuse of said vehicle and a dashboard of said vehicle.

7. The spare tire monitor of claim 5, wherein said first connection is in communication with an onboard computer of said vehicle and a dashboard of said vehicle.

8. The spare tire monitor of claim 1, wherein said gauge is mounted on said dashboard of said vehicle.

9. The spare tire monitor of claim 1, wherein said gauge is configured to issue an alert when a threshold of air pressure loss is detected by said gauge.

10. The spare tire monitor of claim 9, wherein said alert is configured to appear visually within said gauge that is mounted on said dashboard.

11. The spare tire monitor of claim 9, wherein said alert is configured to appear via audio within said gauge that is mounted on said dashboard.

12. The spare tire monitor of claim 9, wherein said alert is configured to appear on said dashboard via a connection between said electrical system of said vehicle and said first connection.

13. A spare tire monitor, comprising:
attaching a first connection and a second connection to a conduit;
placing the second connection over a valve stem of the spare tire such that the valve stem is completely enveloped by an opening of the second connection;
locking the second connection in place over the valve stem;
incorporating a gauge to the first connection such that the gauge is configured to monitor air pressure coming from the valve stem, through the second connection, through the conduit and into the gauge; and
issuing an alert when air pressure contained in the spare tire is detected by the gauge to be less than a desirable amount.

14. The spare tire monitor of claim 13, further comprising mounting the gauge in view of a driver.

15. The spare tire monitor of claim 13, further comprising connecting the first connection to an electrical system of the vehicle such that an alert can be issued when air pressure contained in the spare tire is detected by the gauge to be less than a desirable amount.

16. The spare tire monitor of claim 13, further comprising running the conduit from the second connection, through internal elements of the vehicle and into a front of the vehicle.

17. The spare tire monitor of claim 13, further comprising forming the conduit to be nylon.

18. The spare tire monitor of claim 13, further comprising forming a slot into a trunk of a vehicle such that the slot is stationary and protrudes upward.

19. The spare tire monitor of claim 18, further comprising facing the spare tire so that the valve stem is facing downward toward the floor of the trunk such that the valve stem can be lined up with the slot of the second connection so that the locking mechanism can lock the valve stem in place.

20. A spare tire monitor, comprising:
attaching a first connection and a second connection to a conduit;
placing the second connection over a valve stem of the spare tire such that the valve stem is completely enveloped by the second connection;
locking the second connection in place over the valve stem;
attaching a transmitter to the first connection of the conduit;
placing the transmitter in communication with the gauge;
transmitting a status of air pressure contained within the spare tire to a sensor located within an electrical system of a vehicle; and
alerting a person when air pressure contained in the spare tire is detected by the gauge and transmitted to the sensor to be less than a desirable amount.
